(19) United States
(12) Patent Application Publication
(10) Pub. No.: US 2024/0382970 A1
(43) Pub. Date: Nov. 21, 2024

(54) APPARATUS FOR CONTROLLED RELEASE OF A THERMOCYCLER SEAL

(71) Applicant: Opentrons LabWorks Inc., Brooklyn, NY (US)

(72) Inventors: Shawn Michael Koop, Cottage Grove, MN (US); Taylor Schlaff Goodman, New York, NY (US); Richard Roser, Bellmawr, NJ (US); James Griszbacher, Mount Kisco, NY (US)

(21) Appl. No.: 18/199,857

(22) Filed: May 19, 2023

(51) Int. Cl. B01L 7/00

(52) U.S. Cl. CPC B01L 7/52; B01L 2200/0689; B01L 2300/18

(57) ABSTRACT

An apparatus for controlled separation of a labware from a thermocycler lid. The apparatus includes a seal plate configured to be secured to the thermocycler lid. The seal plate has a seal plate top surface, and a seal plate bottom surface configured to receive a labware seal. A pin is mounted together with a spring on the seal plate at a lateral edge thereof to provide a controlled release of the labware from the thermocycler lid. The spring is disposed to force the pin against an upper edge of the labware such that upon opening the thermocycler lid, the spring causes the pin to extend in contact with the labware, and thereby cause a separation of the labware from the seal plate.

### BACKGROUND

Modern life science research encompasses disciplines such as genetics, genomics, proteomics, and synthetic sequencing. In each of these disciplines, the modification, processing, and/or analysis of liquid biological and chemical samples of interest is fundamental. Thus, thermocyclers are integral to life science research. For example, in molecular biology research alone thermocyclers are used, among other things, for DNA sequencing, cloning, generation of probes, quantification of DNA and RNA, studying patterns of gene expression, and detection of sequence-tagged sites.

Thermocyclers are devices capable of precise temperature control. In some instances, a thermocycler can be configured to regulate temperatures in complicated cyclical programs. A thermocycler typically fully encloses a labware containing liquid samples under a lid mechanism to ensure tightly controlled thermal conditions. A thermal block-typically a piece of fabricated metal such as aluminum-thermally couples the labware (and thereby the liquid samples) to a thermal control system of the thermocycler. Because of this ability to hold precise temperatures with little fluctuation, thermocyclers are commonly used for amplification of DNA and RNA samples, such as by Polymerase Chain Reaction (PCR). In PCR, a thermocycler applies rapid thermal changes to liquid biological and chemical samples. Accordingly, thermocyclers are well suited for any laboratory process where strict temperature control is required.

Various laboratory processes require an airtight seal to be created between the lid mechanism of the thermocycler and each individual liquid sample in the labware. In some cases, this is to prevent evaporation of the liquid samples during protocols involving high temperatures. In some other cases, an air tight seal is required to prevent contamination. Therefore, a sealing sheet, often formed of a sheet of compressible material (e.g., a polymer or silicone), is applied to the lid mechanism of the thermocycler so that an airtight seal is created between the lid mechanism and the labware when the lid mechanism is closed.

However, conventional methods of engaging and disengaging an airtight seal between a labware and a thermocycler lid face several problems. One problem with conventional thermocycler apparatuses is that too great a sealing force can be applied to engage the airtight seal between the thermocycler lid and the labware. As a result, the labware often remains adhered to the sealing sheet at the end of a laboratory process causing the labware to be lifted from the thermocycler. This can lead to spillage, contamination, sample loss, temperature variation and more. Another problem with conventional thermocyclers results from too small a sealing force being applied to the lid. In such cases, no airtight seal is achieved and excessive evaporation or contamination ruin the intended laboratory processes.

Accordingly, there is a need for technologies that overcome the aforementioned deficiencies found in conventional approaches to engaging and disengaging a seal of a thermocycler lid.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1A is an isometric view of a conventional thermocycler device, shown with the thermocycler lid disposed in an open position with a labware disposed within the thermal block of the thermocycler.

FIG. 1B is a cross-sectional view of a conventional thermocycler device shown during opening of the thermocycler lid and illustrating the labware being lifted from the thermal block.

FIG. 2 is an isometric view of a thermocycler device, according to an embodiment of this disclosure.

FIG. 3 is an isometric view of an apparatus for controlled release of a thermocycler seal contacting a labware, according to an embodiment of this disclosure.

FIG. 4 is a cross-sectional view of a thermocycler device shown during opening of the thermocycler lid and illustrating the labware being lifted from the thermal block, with the apparatus for controlled release, according to an embodiment of this disclosure.

### DETAILED DESCRIPTION

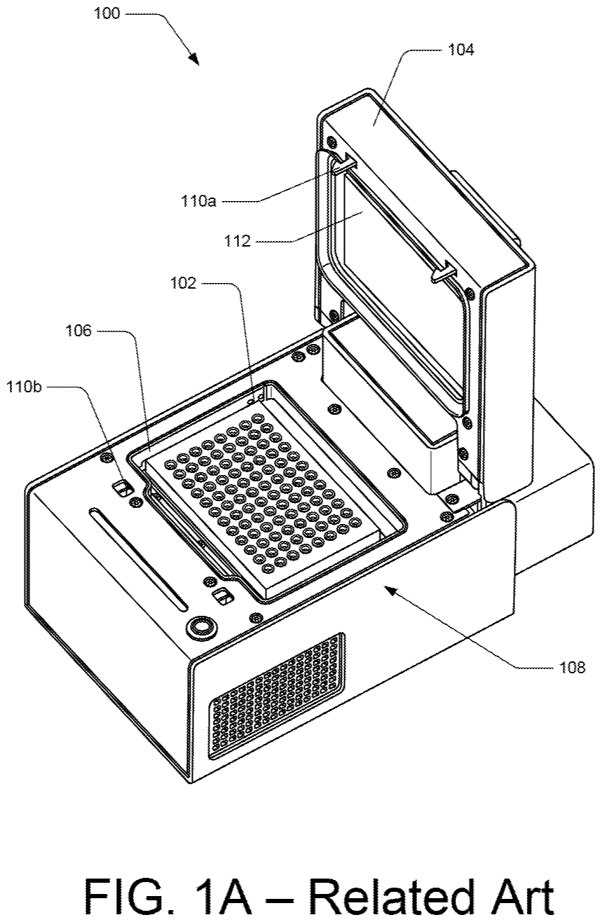

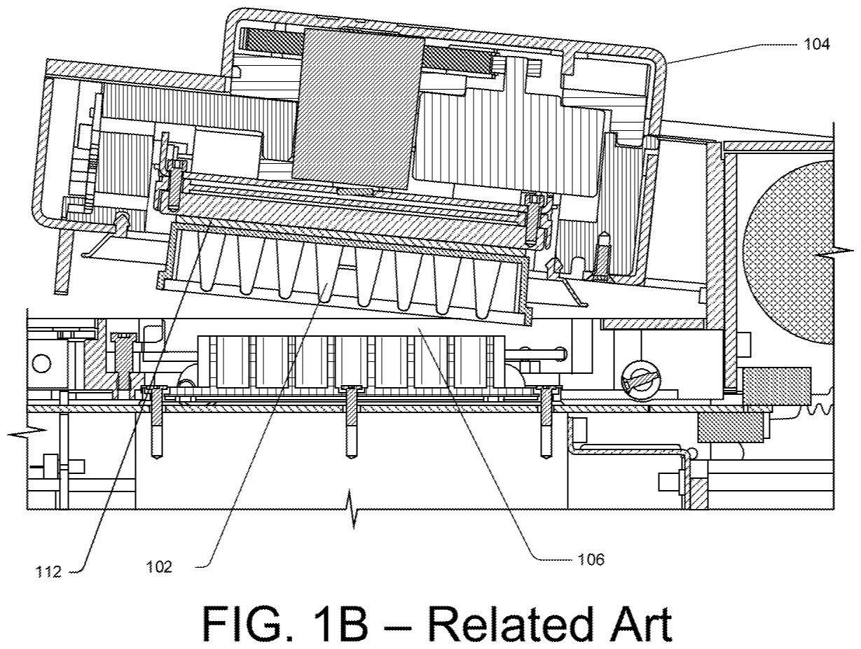

FIG. 1A is an isometric view of a conventional thermocycler device 100 that is used, at least in part, to permit a thermal transfer generated in the thermocycler device 100 to liquid samples within a labware 102 configured to be accommodated therein. The labware 102 is a sterile object, and is generally configured to carry multiple liquid samples, typically arranged in an array configuration of wells which isolate the samples (e.g., 96 wells, 384 wells, etc.). The well configuration provides a thermal pathway to the thermal transfer to the liquid samples in the wells of the labware 102. Thermal activity within the thermocycler device 100 may be controlled by an internally arranged thermal control system (not specifically shown).

The thermocycler device 100 includes a lid 104, which is shown disposed in an open position. The labware 102 is shown disposed within a thermal block 106 of the thermocycler device 100. The thermal block 106 thermally couples the labware 102 to the thermocycler device 100 such that the thermal transfer may be controlled by the thermal control system.

As shown in in FIG. 1A, the thermal block 106 is typically located within an inner section of the body 108 of the thermocycler device 100. As indicated above, the thermal block 106 and the labware 102 together facilitate thermal coupling of the labware 102 (and thereby the liquid samples) to the thermal control system.

Conventional thermocycler devices, like thermocycler device 100, typically include a lid securing mechanism for closing and securing the lid 104 during operation. An example lid securing mechanism 110a/110b may include a latch (110a) and catch (110b) system, such as the push-to-close latch system shown in FIG. 1A. Thus, when the lid 104 is closed, one or more latch members 110a located in the lid 104 are pushed in against a mating surface 110b in the body 108 to hook around a striker therein to secure the thermocycler lid 104 from inadvertent opening. Moreover, when the lid 104 is closed, a sealing sheet 112, which is disposed on an inside face of the lid 104, is pressed against the upper surface of the labware 102. Nevertheless, conventional thermocycler devices, such as that depicted in FIG. 1A, frequently suffer from improperly disengaging the labware 102 from the sealing sheet 112, as described below.

FIG. 1B is a cross-sectional view of a conventional thermocycler device 100 shown during opening of the lid 104, and illustrating the labware 102 being lifted from the thermal block 106. Such dislodging of the labware 102 from the thermal block 106 often results from the labware 102 remaining adhered to the sealing sheet 112 at the end of a procedure, for example, where the thermocycler has completed a desired procedure and the labware is ready for removal. The sealing sheet 112 is typically a sheet of compressible material (e.g., silicone gel or ethylene propylene diene monomer (EPDM)) that is applied either to the top of the labware 102 or to the underside of the lid 104 for the purposes of limiting sample evaporation and further isolating individual samples from potential contamination. To this end, compressive force must be applied to engage an airtight seal between the labware 102 and the sealing sheet 112.

Application of too great a compressive force when configuring the airtight seal may cause the labware 102 and the sealing sheet 112 to simultaneously be displaced by the opening of the lid 104. The requisite force that must be applied to achieve a sufficient seal will vary due a number of factors such as manufacturing tolerances, compliance of the seal material, and variable labware well temperature. The total adhesive strength of the seal is determined by the frictional forces between the sealing sheet 112 and surfaces of the labware 102, and the negative relative pressure inside each sealed well (i.e. of the labware 102). Proper disengagement of the sealing sheet 112 from the labware 102 therefore requires an opposing force sufficient to overcome the total adhesive strength of the seal. As indicated above, conventional thermocycler designs lack means to ensure proper disengagement of the sealing sheet 112 from the labware 102.

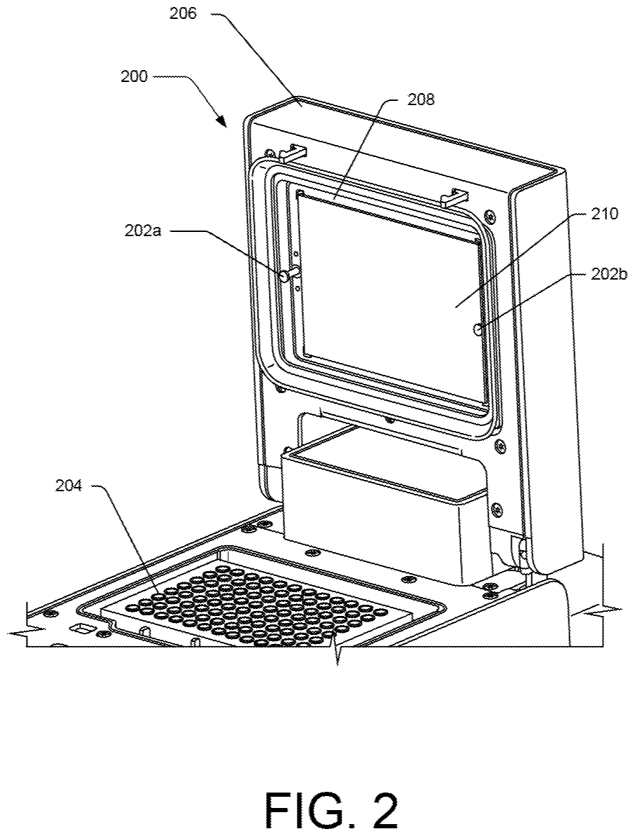

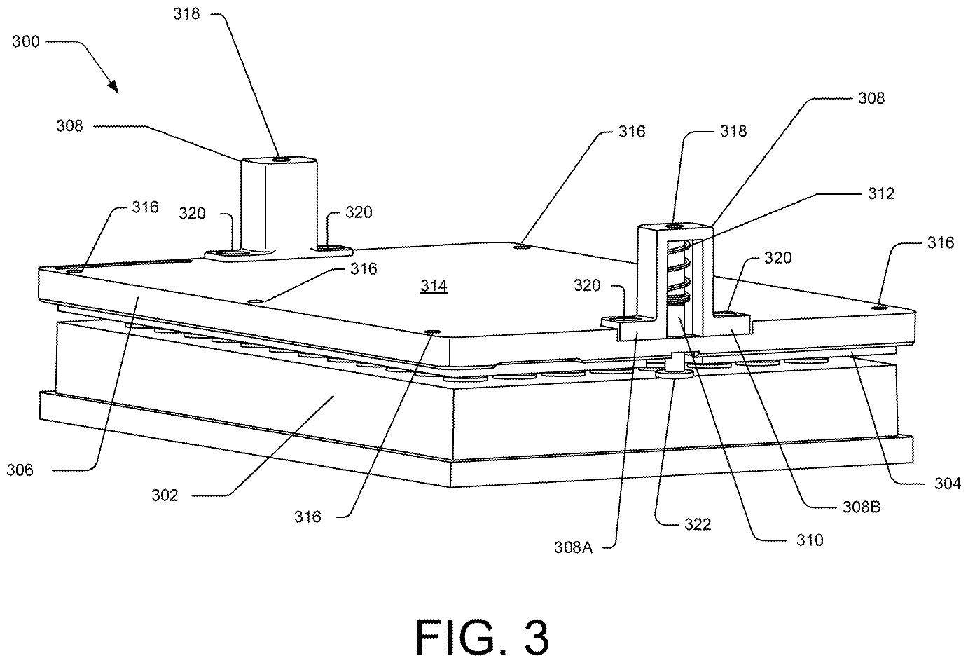

FIG. 2 is an isometric view of an embodiment according to the instant disclosure of a thermocycler device 200 including an apparatus 202 for controlled release of a labware 204 from a lid 206. In an embodiment, the apparatus 202 may be disposed within the lid 206. Although the apparatus 200 may include only one release pin 202a or 202b (discussed hereinafter), the apparatus may include more than one, such as for example two, three, or four, or more. For example, FIG. 2 shows the apparatus 202 may include two controlled release pins 202a/202b (discussed in greater detail with respect to FIG. 3 below) extending from a sealing plate 208.

In an embodiment as shown in FIG. 2, the sealing plate 208 may be secured to an underside of the lid 206. In an embodiment, the sealing plate 208 (and therefore the apparatus for controlled release of the thermocycler seal) may be removably secured to the lid 206. In an embodiment, at least a portion of a contacting surface of the sealing plate 208 that contacts the underside of lid 206 may include a magnetic material. Accordingly, the lid 206 of such an example embodiment (or at least the underside of the lid 206 or a portion thereof) may also include a magnetic material of the same or similar composition (e.g., iron, steel, nickel, cobalt, etc.). Additionally, and/or alternatively, the lid 206 may be in electrical communication with a power source of the thermocycler device 200 such that when a current is passed through the lid 206, at least a portion thereof exhibits magnetic properties capable of securing the sealing plate 208 to the lid 206, such as through use of an electromagnet. In an alternative embodiment not shown, the sealing plate may be formed integrally or monolithically with the thermocycler lid.

In an embodiment, the thermocycler device 200 may further include a sealing sheet 210. Controlled release of the sealing sheet 210 from the labware 204 requires sufficient force to overcome the total seal strength. The strength of seal adhesion to the labware 204 is based on a combination of frictional force between the sealing sheet 210 and surfaces of the labware 204, and negative relative pressure inside each sealed well due to a temperature differential from the well to ambient conditions. The total force of the adhesion is then the sum of the contribution of all of the individual wells of the labware 204. This force may be relatively high and difficult to control if the total sum force of seal adhesion is released simultaneously, and so an incremental release of individual wells is advantageous.

Turning back now to the embodiment illustrated in FIG. 2, the two controlled release pins 202a/202b of apparatus 202 are shown positioned at lateral edges of the seal plate 208 on the perimeter of the sealing sheet 210. Alternatively, it is understood that one or more release pins 202a/202b may be positioned elsewhere with respect to the labware to be able to release the labware, though other positions may be more or less successful, such as at one or more corner locations. In an embodiment, the sealing plate 208 may include a sealing plate bottom surface (not shown) that may receive the sealing sheet 210. The sealing sheet 210 may be a standard or commercially available adhesive-backed thermocycler seal. Accordingly, the sealing plate bottom surface may generally define a receiving surface area on which to receive the sealing sheet 210. For example, the receiving surface area may include the entirety of the sealing plate bottom surface or less than the entirety. Further, the receiving surface area may be formed of a material composition different than that of other surfaces of the sealing plate 208. Thus, the receiving surface area may comprise materials or substances having relatively higher sterility, thermal conductivity, etc. In the embodiment in FIG. 2, the sealing plate bottom surface is defined within a recess suitable to conform to, accommodate, or otherwise house the labware 204 when the thermocycler lid 206 is closed. In other embodiments, the sealing plate bottom surface may be substantially planar or non-conformal.

In an embodiment, the respective controlled release pins 202a/202b of apparatus 202 may be mounted at opposing lateral edges of the sealing plate 208 and the sealing sheet 210. As such, when the lid 206 is in the closed position, the controlled release pins 202a/202b of apparatus 202 may contact the labware 204 on a top surface near peripheral edges thereof. The apparatus 202 is thus positioned to apply downward force in opposition to the lifting force at the periphery of the labware 204 during opening of the lid 206.

FIG. 3 is an isometric view of an apparatus 300 for mechanically actuated controlled release of a thermocycler seal between a labware 302 and a sealing sheet 304, according to an embodiment of this disclosure. In an example embodiment, apparatus 300 may include a sealing plate 306, which may be similar to the sealing plate 208, one or more controlled release housings 308, and one or more controlled release pins 310 mounted with one or more controlled release springs 312, respectively, disposed within the controlled release housings 308. Thus, a spring 312 loaded on the pin 310 provides a form of mechanical actuation, in a simple embodiment. Notably, other forms of mechanical actuation to provide a controlled release of the sealing plate 208 are contemplated and considered to be part of the scope of this disclosure, including, for example: shape-memory materials put under a bias position against the labware when the lid is closed, but which return to a different position upon release, thereby pressing against the labware; gears and cam combinations, where a cam is positioned to press on the labware upon opening the lid; resilient materials (i.e., rubber, etc.) which provide a mechanical pull on the labware; etc.

As shown, the sealing plate 306 may be substantially planar in consideration of ergonomic or other design factors so as to facilitate use within commercially available thermocycler systems. Alternatively, the sealing plate 306 may be textured, have contours, or even a frame lidding, (not shown). The sealing plate 306 has a top surface 314 and a bottom surface (not shown). The top surface 314 of sealing plate 306 may include a plurality of mounting apertures 316. The mounting apertures 316 may be configured to receive a fastener (not shown) for removably securing the sealing plate 306 to the lid (not shown in FIG. 3). Accordingly, conventional thermocycler devices may be retrofitted, in some instances, to receive a sealing plate according to the instant disclosure.

Generally, the sealing plate bottom surface may adhesively receive a sealing sheet 304, which may be similar to the sealing sheet 210 described above with reference to FIG. 2. The sealing plate 306 may accordingly be configured to facilitate thermal coupling of the labware 302 (and hence, the chemical or biological samples of interest) to a thermal control system of a thermocycler. In an embodiment, the sealing plate 306 may be temperature controlled for such purpose. That is, the sealing plate 306 may be in electrical communication with the thermal control system of a thermocycler device such that sealing plate 306 is maintained at one or more precise temperatures throughout a thermocycler process. For example, a Peltier system may be configured within a thermocycler device wherein electrical current is passed through the sealing plate 306 to effect temperature changes. The sealing plate 306 of embodiments may therefore include any suitably electrically conductive material. By passing an appropriate electrical current through the sealing plate 306, the sealing plate 306 may be maintained in thermal equilibrium with a thermal block of the thermocycler system.

FIG. 3. further illustrates controlled release housings 308 protruding from the sealing plate top surface 314. The controlled release housings 308 may be positioned on the sealing plate top surface 314 near a midpoint of a lateral edge of the sealing plate 306, or, of course, wherever the one or more controlled release pins 310 are mounted. Generally, the controlled release housings 308 may include a pair of flanges 308A/308B extending oppositely and laterally from the sides of the release housings 308, along the edge of the top surface 314 of the sealing plate 306. The flanges 308A/308B may include apertures 320 therethrough that are configured to receive fasteners (not shown) for securing the controlled release housing 312 to a thermocycler lid. Thus configured, the controlled release housings 308 may be secured to the sealing plate 306. In some instances (not shown here), one or more controlled release housings 308 may be retrofitted to a sealing plate via the apertures 320. Though, the controlled release housings 308 may be secured to the sealing plate 306 by any suitable means, including but not limited to adhesives, magnetics, welding, snap-to-fit molding, etc. Alternatively, in an embodiment, one or more controlled release housings 308 may be formed integrally with the sealing plate 306.

The controlled release housings 308 may generally define an inner controlled release section that slidably receives a pin 310 and a spring 312. For example, the sealing plate 306 may include apertures (as seen in FIG. 3) through one or more lateral edges near the midpoint that may slidably receive a pin 310. Such an aperture formed in the sealing plate 306 is positioned to be vertically aligned with an aperture 318 formed in a top surface of a controlled release housing 312. Accordingly, the upper end of the controlled release pin 310 may be disposed substantially within the controlled release aperture 318 when a thermocycler lid (to which the sealing plate 306 is attached) is in a closed position.

The pin 310 is positioned to cause a separation of the labware 302 from the sealing plate 306 (and hence, the sealing sheet 320). The illustrated pin 310 is shown mounted together with the spring 312. In an embodiment, the pin 310 may generally be cylindrical or rod-shaped. The pin 310 may include an upper end whereon the spring 312 is disposed. In an embodiment, the upper end of the pin 310 may have a diameter that is different than other portions of the pin 310 (i.e., the pin 310 may have a non-uniform shape or diameter). For example, the upper end of the pin 310 may be configured with a diameter corresponding to that of the spring 312. In an embodiment as described in further detail below, the upper end of the pin 310 may be tapered so as to accommodate a conically shaped spring 312. The pin 310 may further include a lower end terminating in a contacting surface 322 configured to contact the labware 302. In some embodiments, the contacting surface 322 may be advantageously shaped to contact a maximum possible surface area of the labware 302 to facilitate separation of the labware 302 from the sealing plate 306. In an embodiment, the contacting surface 322 may be shaped as a circle, square, triangle, etc.

The spring 312 may be disposed to force the pin 310 against an upper edge of the labware 302 such that upon opening a thermocycler lid, the spring 312 causes the pin 310 to extend in contact with the labware 302. Generally, an incremental release of the airtight seal from individual wells is advantageous to preserve sample volume, etc. The spring 312 may be configured to provide force in opposition to adhesive forces resulting from the airtight seal. In an embodiment, the spring 312 may be configured to push the pin 310 against the upper edge of the labware with a constant force throughout the process of opening the thermocycler lid. Accordingly, the spring 312 may be a compression spring having a constant diameter.

In an alternative embodiment, the spring 312 may be configured to push the pin 310 with non-constant force. For example, more or less force may be required at particular points in the process of opening the thermocycler lid. As one non-limiting example, the spring 312 may be configured to push the pin 310 with a maximum force upon an initial part of the opening of the thermocycler lid, while pushing the pin 310 with less force throughout the remainder of the opening process. Accordingly, the diameter of the spring 312 may vary. In an embodiment, the spring 312 may be a conically shaped compression spring or an hourglass-shaped compression spring. Thus, as discussed briefly above, the pin 310 may include an upper end with varying diameter so as to accommodate the spring 312.

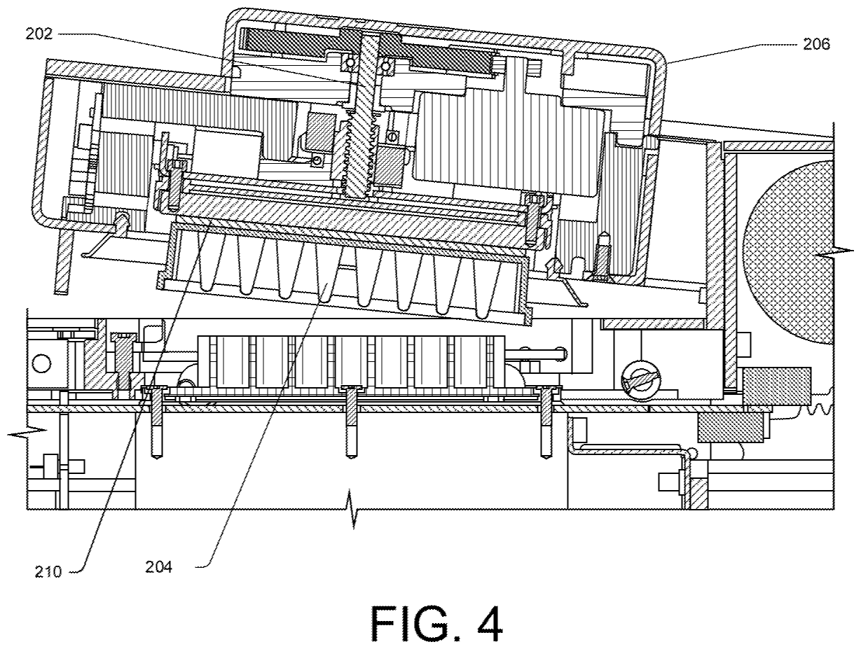

FIG. 4 as indicated above, depicts a cross-sectional view of the apparatus 202 in the lid 206 of the thermocycler device 200. One of the controlled release pins 202a/202b is shown in cross-section as well, in a position prepared to push against the stuck labware 204.

Moreover, in an alternative embodiment not shown, it is understood that the concept of the spring pins might be implemented into the labware instead of into the lid of a thermocycler instead. Additionally, another alternative embodiment not shown may include a system where the controlled release pins are pushed via a motorized piston or other mechanical or electrical means different than a spring.

The preceding description has been provided to enable others skilled in the art to best utilize various aspects of the example embodiments disclosed herein. This example description is not intended to be exhaustive or to be limited to any precise form disclosed.

Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and/or indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus for controlled separation of a labware from a thermocycler lid, the apparatus comprising:
a seal plate configured to be secured to the thermocycler lid, the seal plate having:
a top surface, and
a bottom surface configured to receive a labware seal; and
a pin mounted with a spring on the seal plate at a lateral edge thereof to provide a controlled release of the labware from the thermocycler lid, the spring disposed to force the pin against an upper edge of the labware such that, upon opening the thermocycler lid, the spring causes the pin to extend in contact with the labware, and thereby cause a separation of the labware from the seal plate.

2. The apparatus of claim 1, wherein the pin mounted together with the spring is a first pin mounted together with a first spring,
wherein the lateral edge is a first lateral edge, and
wherein the apparatus further comprises:
a second pin mounted together with a second spring on the seal plate, disposed at a second lateral edge of the seal plate, the second lateral edge being opposite the first lateral edge.

3. The apparatus of claim 1, wherein the spring is a compression spring having a constant diameter.

4. The apparatus of claim 1, wherein the pin has a tapered upper end, and
wherein the spring is a conical compression spring.

5. The apparatus of claim 1, wherein the sealing plate bottom surface defines a recess configured to enclose an upper surface of the labware upon closing the thermocycler lid.

6. The apparatus of claim 1, wherein the sealing plate is configured to be temperature controlled.

7. The apparatus of claim 1, wherein the sealing plate is removably secured to the thermocycler lid.

8. The apparatus of claim 7, wherein the sealing plate includes a plurality of mounting apertures configured to receive a fastener for securing the sealing plate to the thermocycler lid.

9. The apparatus of claim 7, wherein at least a portion of the sealing plate is configured to magnetically engage the thermocycler lid.

10. The apparatus of claim 1, wherein the pin includes:
an upper end whereon the spring is disposed, and
a lower end terminating in a contacting surface configured to contact the labware.

11. The apparatus of claim 10, wherein the contacting surface is substantially planar.

12. The apparatus of claim 1, wherein the sealing plate includes a housing having an inner section,
wherein the pin and the spring are slidably mounted within the housing, and
wherein the housing is disposed near a midpoint of the lateral edge of the sealing plate.

13. A thermocycler lid comprising:
a receiving surface configured to receive a labware sealing sheet; and
a plurality of pins mounted with respective springs on one or more lateral edges of the receiving surface, each spring being disposed to force a respective pin of the plurality of pins against an upper surface of a labware, when the thermocycler lid is in a closed position on a thermocycler device such that, upon opening the thermocycler lid, the controlled release spring causes the controlled release pin to extend in contact with the labware, and thereby cause a separation of the labware from the labware sealing sheet.

14. The thermocycler lid of claim 13, wherein the spring is a compression spring having a constant diameter.

15. The thermocycler lid of claim 13, wherein the pin includes a tapered upper end, and
further wherein the spring is a conical compression spring.

16. The thermocycler lid of claim 13, wherein the receiving surface defines a recess configured to enclose an upper surface of the labware upon closing the thermocycler lid.

17. The thermocycler lid of claim 13, wherein the receiving surface is configured to be temperature controlled.

18. The thermocycler lid of claim 13, wherein the release pin includes an upper end whereon the individual spring is disposed and a lower end terminating in a contacting surface configured to contact the labware.

19. An apparatus for controlled separation of a labware from a thermocycler lid, the apparatus comprising:
a seal plate configured to be secured to the thermocycler lid, the seal plate having:
a top surface, and
a bottom surface configured to receive a labware seal; and
a pin mounted on the seal plate at a lateral edge thereof to provide a controlled release of the labware from the thermocycler lid, the pin being positioned to create force against an upper edge of the labware such that, upon opening the thermocycler lid, the pin presses against the labware, and thereby cause a separation of the labware from the seal plate.

20. The apparatus of claim 19, wherein the pin is mechanically actuated against the labware.
